(19) United States
(12) Patent Application Publication
(10) Pub. No.: US 2025/0183638 A1
(43) Pub. Date: Jun. 5, 2025

(54) WIRE HARNESS PROTECTION MEMBER

(71) Applicants: Yazaki Corporation, Tokyo (JP); TOYOTA JIDOSHA KABUSHIKI KAISHA, Toyota-shi (JP)

(72) Inventors: Akinori NAKASHIMA, Shizuoka (JP); Takuya NAKAGAWA, Shizuoka (JP); Takeshi ISHIKAWA, Shizuoka (JP); Yoshihiko SATO, Shizuoka (JP); Itsuo WAKABAYASHI, Seto-shi (JP)

(73) Assignees: Yazaki Corporation, Tokyo (JP); TOYOTA JIDOSHA KABUSHIKI KAISHA, Toyota-shi (JP)

(21) Appl. No.: 18/941,305

(22) Filed: Nov. 8, 2024

(30) Foreign Application Priority Data
Dec. 5, 2023 (JP) 2023-205569

(51) Int. Cl. H02G 3/04; H01B 7/18

(52) U.S. Cl. CPC H02G 3/0481; H01B 7/1875

(57) ABSTRACT

A wire harness protection member has: a protector constituted of a plurality of sheet materials overlapping each other; and a fixing portion which fixes both end portions of the protector to each other, in which the plurality of sheet materials has same materials and same shapes, in the protector, the plurality of sheet materials overlaps each other such that one of the sheet materials covers a whole of another of the sheet materials, the protector has an inner side surface facing a wire harness in a state of being wound around the wire harness, and is wound around the wire harness by facing the inner side surfaces of both end portions of the protector to each other, and the fixing portion fixes the plurality of sheet materials to each other along a laminating direction in which the plurality of sheet materials is laminated.

### CROSS-REFERENCE TO RELATED APPLICATION(S)

The present application claims priority to and incorporates by reference the entire contents of Japanese Patent Application No. 2023-205569 filed in Japan on Dec. 5, 2023.

### BACKGROUND OF THE INVENTION

### 1. Field of the Invention

The present invention relates to a wire harness protection member.

### 2. Description of the Related Art

Conventionally, there is a structure that protects a wire harness. International Publication No. 2012/008364 discloses a wire harness protection structure including: a protection member that covers an outer circumference of a wire harness at a predetermined location; and a fixing adhesive tape having a starting end portion that is wound around and fixed to the wire harness and a terminal end portion that is wound around an outer circumference of the protection member to fix the protection member, the terminal end portion being wound around and fixed to the wire harness on a side opposite to the starting end portion with the protection member interposed therebetween.

In the wire harness protection member, if a dedicated protection member is manufactured according to the required protection performance, then this results in an increase in the number of types of members. It is desirable to enable to manufacture a protection member according to the required protection performance while suppressing an increase in the number of types of members.

### SUMMARY OF THE INVENTION

An object of the present invention is to provide a wire harness protection member capable of realizing the required protection performance while suppressing an increase in the number of types of members.

In order to achieve the above mentioned object, a wire harness protection member according to one aspect of the present invention includes a protector constituted of a plurality of sheet materials overlapping each other; and a fixing portion which fixes both end portions of the protector to each other, wherein the plurality of sheet materials has same materials and same shapes, in the protector, the plurality of sheet materials overlaps each other such that one of the sheet materials covers a whole of another of the sheet materials, the protector has an inner side surface facing a wire harness in a state of being wound around the wire harness, and is wound around the wire harness by facing the inner side surfaces of both end portions of the protector to each other, and the fixing portion fixes the plurality of sheet materials to each other along a laminating direction in which the plurality of sheet materials is laminated.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a front view of a wire harness protection member according to an embodiment;

FIG. 2 is a perspective view of the wire harness protection member according to the embodiment;

FIG. 3 is a cross-sectional view of the wire harness protection member according to the embodiment;

FIG. 4 is a perspective view of a sheet material according to the embodiment;

FIG. 5 is a perspective view of a protector according to the embodiment;

FIG. 6 is a diagram illustrating the protector wound around the wire harness;

FIG. 7 is a perspective view of the sheet material according to the embodiment;

FIG. 8 is a cross-sectional view of the sheet material according to the embodiment;

FIG. 9 is a plan view of the sheet material according to the embodiment;

FIG. 10 is a plan view of the sheet material according to the embodiment;

FIG. 11 is a perspective view of the sheet material according to the embodiment;

FIG. 12 is a perspective view of the wire harness protection member according to the embodiment;

FIG. 13 is a perspective view of the wire harness protection member according to the embodiment;

FIG. 14 is a perspective view of the wire harness protection member according to the embodiment;

FIG. 15 is a perspective view of the wire harness protection member according to the embodiment;

FIG. 16 is a side view of the wire harness protection member according to the embodiment;

FIG. 17 is a perspective view of the sheet material according to the embodiment;

FIG. 18 is a perspective view of the protector according to the embodiment;

FIG. 19 is a cross-sectional view of the wire harness protection member according to the embodiment;

FIG. 20 is a perspective view of the protector according to the embodiment;

FIG. 21 is a perspective view of the protector according to the embodiment; and

FIG. 22 is a perspective view of the protector according to the embodiment.

### DETAILED DESCRIPTION OF THE PREFERRED EMBODIMENTS

A wire harness protection member according to embodiments of the present invention will be described in detail below with reference to the drawings. Note that the present invention is not limited by the embodiments. Further, the components in the following embodiments include those which can be easily assumed by those skilled in the art or those which are substantially the same.

### Embodiment

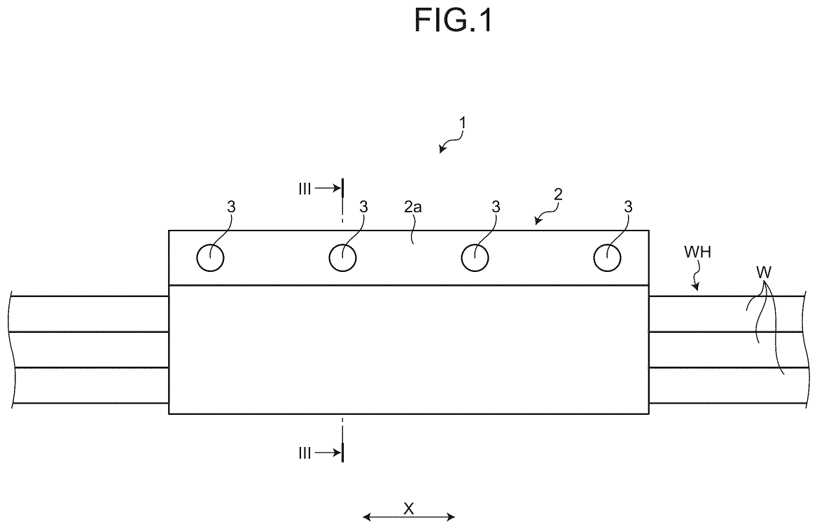

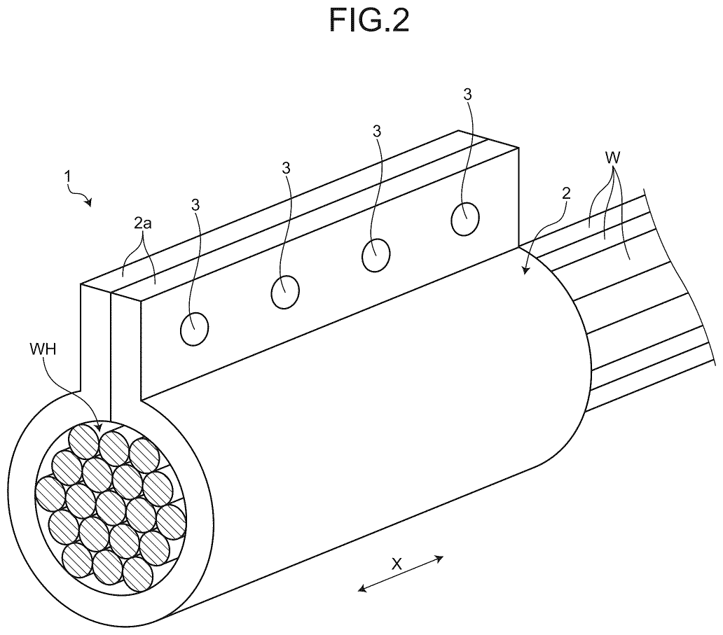

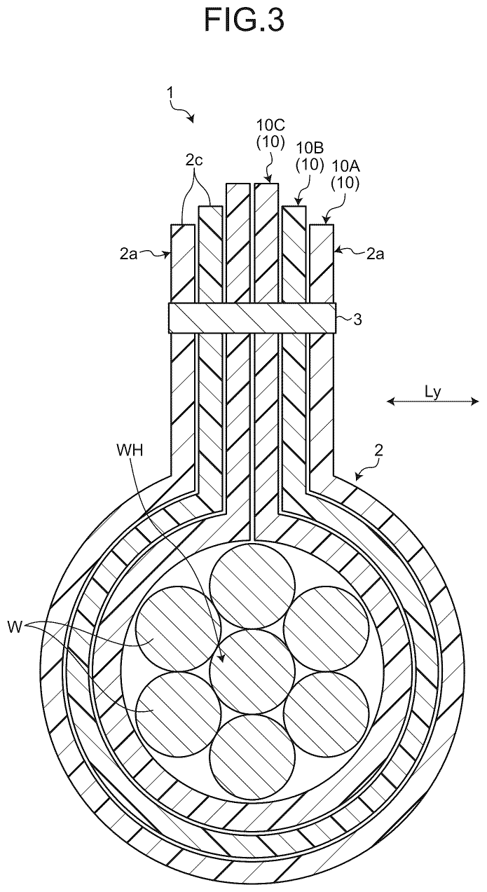

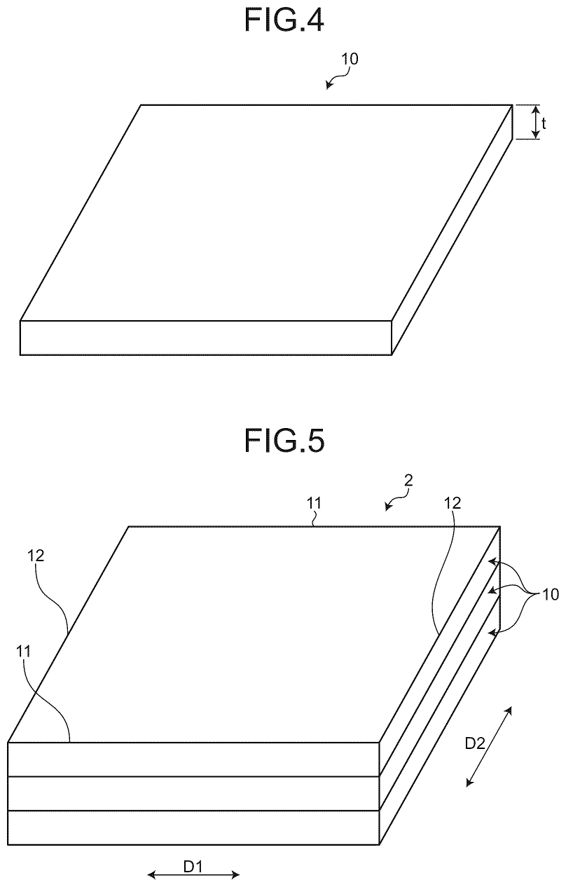

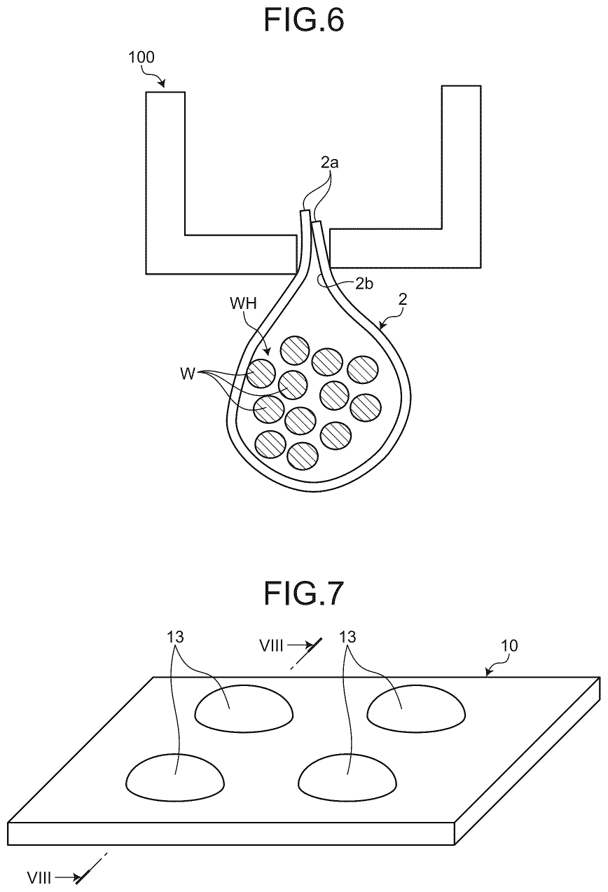

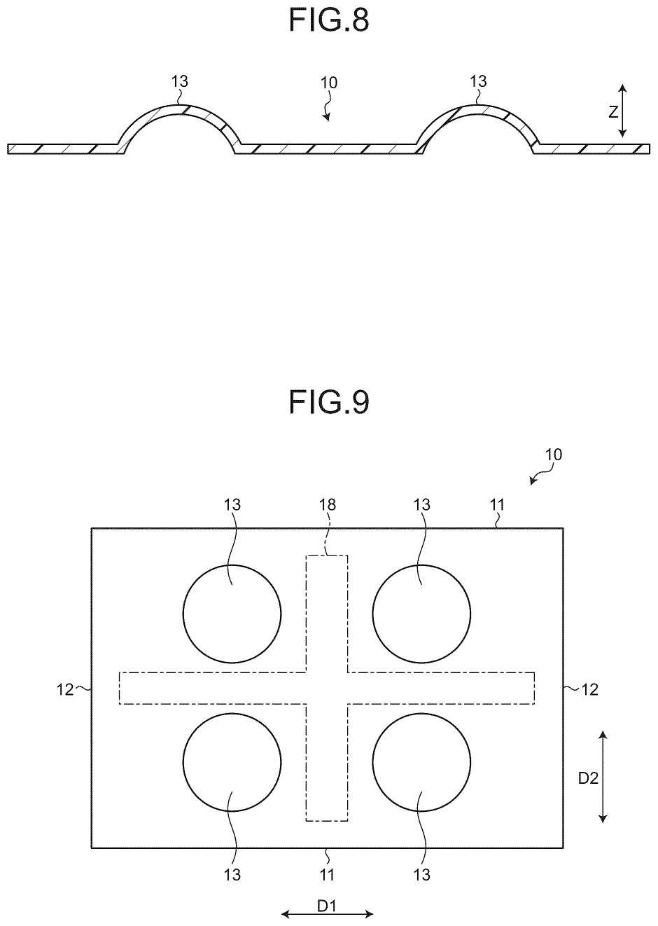

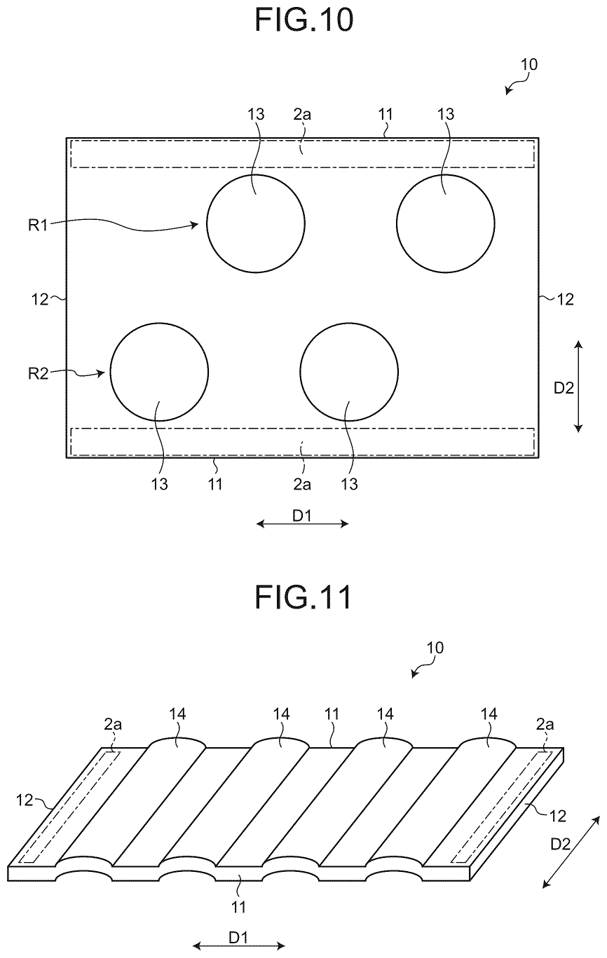

An embodiment will be described with reference to FIGS. 1 to 22. The present embodiment relates to a wire harness protection member. FIG. 1 is a front view of a wire harness protection member according to an embodiment, FIG. 2 is a perspective view of the wire harness protection member according to the embodiment, FIG. 3 is a cross-sectional view of the wire harness protection member according to the embodiment, FIG. 4 is a perspective view of a sheet material according to the embodiment, FIG. 5 is a perspective view of a protector according to the embodiment, FIG. 6 is a diagram illustrating the protector wound around the wire harness, FIG. 7 is a perspective view of the sheet material according to the embodiment, FIG. 8 is a cross-sectional view of the sheet material according to the embodiment, and FIGS. 9 and 10 are plan views of the sheet material according to the embodiment.

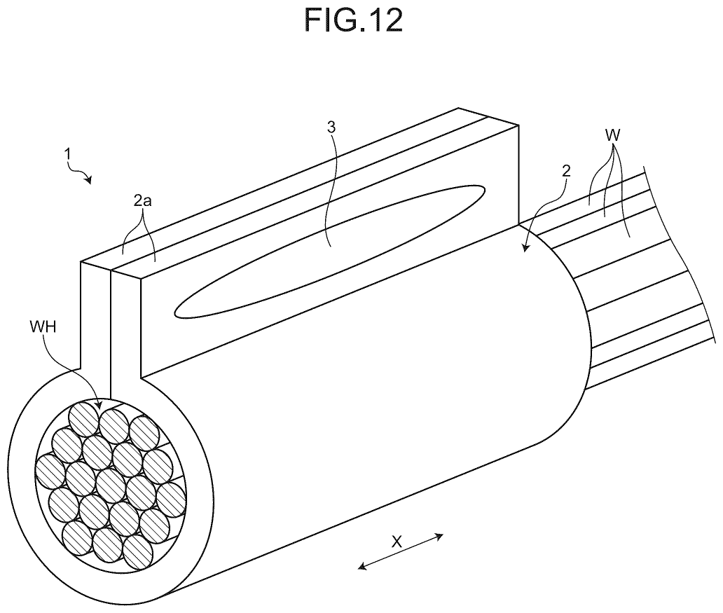

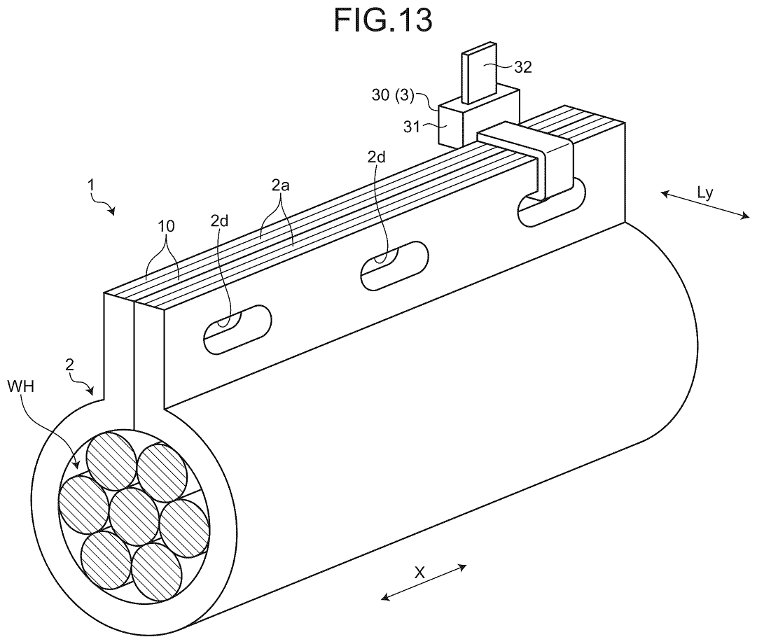

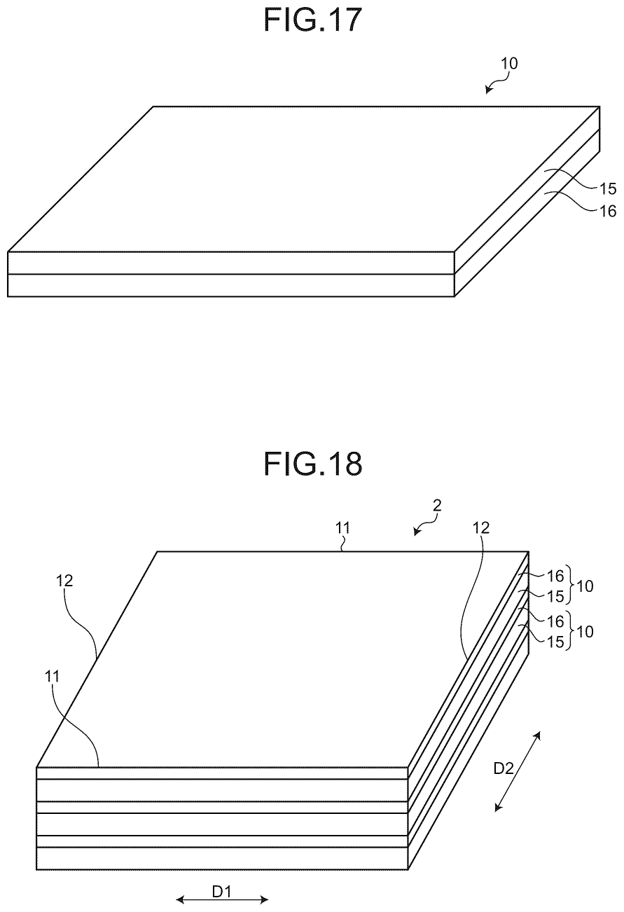

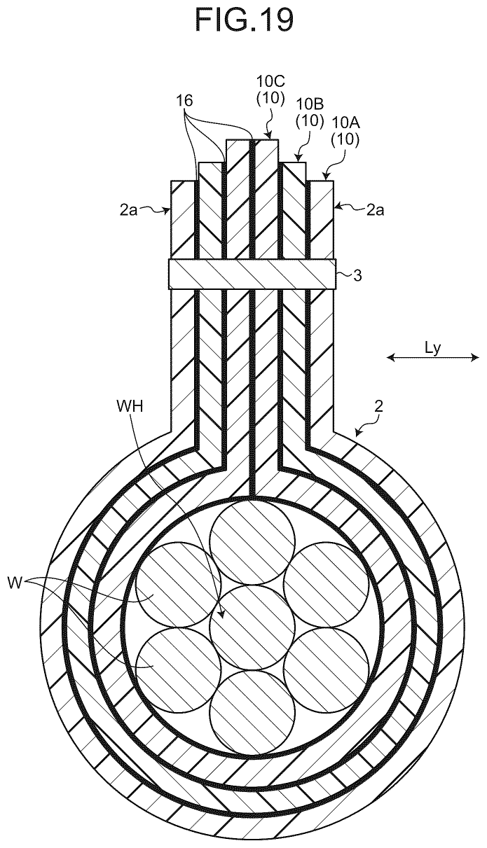

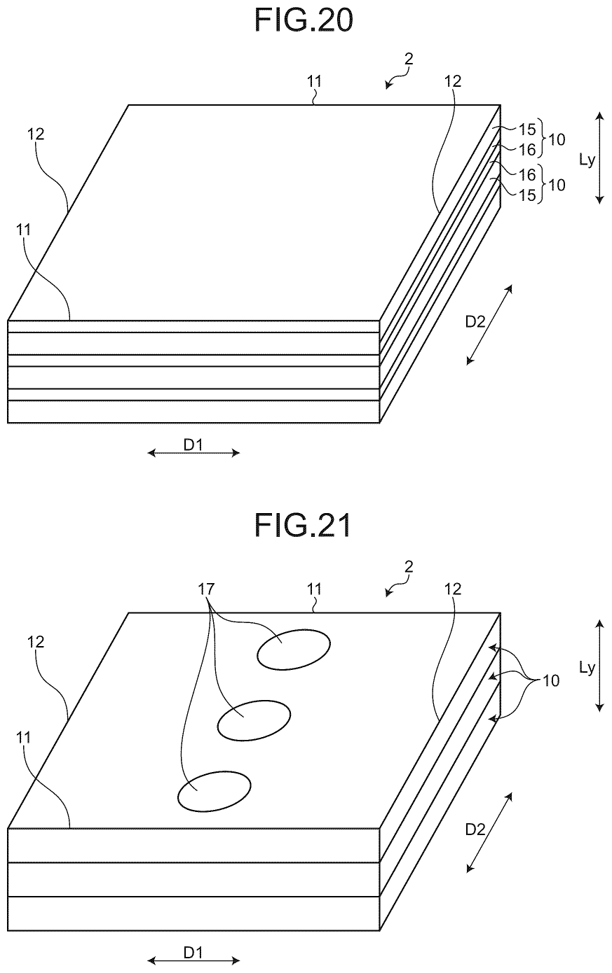

FIG. 11 is a perspective view of the sheet material according to the embodiment, FIGS. 12 to 15 are perspective views of the wire harness protection member according to the embodiment, FIG. 16 is a side view of the wire harness protection member according to the embodiment, FIG. 17 is a perspective view of the sheet material according to the embodiment, FIG. 18 is a perspective view of the protector according to the embodiment, FIG. 19 is a cross-sectional view of the wire harness protection member according to the embodiment, and FIGS. 20 to 22 are perspective views of the protector according to the embodiment. FIG. 3 illustrates a cross section taken along line III-III of FIG. 1. FIG. 8 illustrates a cross section taken along line VIII-VIII of FIG. 7.

As illustrated in FIGS. 1 and 2, a wire harness protection member 1 of the present embodiment is a member that is attached to a wire harness WH to protect the wire harness WH. The wire harness protection member 1 has a protector 2 and a fixing portion 3. The protector 2 is wound around the outside of the wire harness WH to protect the wire harness WH. The fixing portion 3 fixes two end portions 2a and 2a of the protector 2 to each other.

As illustrated in FIG. 3, the protector 2 is constituted of a plurality of sheet materials 10 overlapping each other. The fixing portion 3 fixes the plurality of sheet materials 10 to each other along the laminating direction Ly in which the sheet materials 10 are laminated. The fixing portion 3 is formed by, for example, welding. However, the fixing portion 3 may be a member attached to the protector 2, and may be, for example, a clip or a binding member.

In the wire harness protection member 1 of the present embodiment, the rigidity and flexibility of the protector 2 can be adjusted by the number of the sheet materials 10 to be laminated. In other words, it is possible to constitute the protector 2 having different protection performances according to the number of the sheet materials 10 to be used. In the wire harness protection member 1 of the present embodiment, since it is not necessary to keep a plurality of types of protection members having different shapes in stock, the simplification of the stock management is realized.

As illustrated in FIG. 4, the sheet material 10 of the present embodiment has a rectangular shape. The sheet material 10 is molded of a flexible insulating synthetic resin. The material of the sheet material 10 is, for example, soft polyvinyl chloride (PVC). The exemplified sheet material 10 has a flat plate shape. The thickness t [mm] of the sheet material 10 is determined such that the sheet material 10 has appropriate flexibility and appropriate strength.

As illustrated in FIG. 5, the protector 2 is constituted of a plurality of sheet materials 10 overlapping each other. The plurality of sheet materials 10 constituting the protector 2 have same materials and same shapes. In other words, the material and shape of one sheet material 10 constituting the protector 2 are the same as the material and shape of other sheet material 10 constituting the protector 2. All sheet materials 10 have the same dimensions. For example, when the shape of the sheet material 10 is rectangular, the lengths of corresponding sides 11 and 12 and the thicknesses t in the plurality of sheet materials 10 are the same.

As illustrated in FIG. 5, the plurality of sheet materials 10 overlaps each other such that one of the sheet materials 10 covers the whole of another of the sheet materials 10. The exemplified rectangular sheet material 10 has a pair of first sides 11 and a pair of second sides 12. The first side 11 of one of the sheet materials 10 is overlapped with the first side 11 of another of the sheet materials, and the second side 12 of one of the sheet materials 10 is overlapped with the second side 12 of another of the sheet materials 10.

As illustrated in FIG. 6, the protector 2 is wound around the wire harness WH. The wire harness WH includes at least one electric wire W. The exemplified wire harness WH includes a plurality of electric wires W. The protector 2 is wound around the wire harness WH so as to wrap the wire harness WH. Note that the protector 2 may be held in advance by a jig or the like so as to have a substantially U-shape or V-shape. In this case, the wire harness WH is placed in the held protector 2.

The protector 2 wound around the wire harness WH has an inner side surface 2b. The inner side surface 2b is a surface facing the wire harness WH and forms a space portion for accommodating the wire harness WH. The protector 2 is wound around the wire harness WH by facing the inner side surfaces 2b of the two end portions 2a to each other.

The fixing portion 3 that fixes both end portions 2a to each other is formed by, for example, a welding machine 100. The means of welding by the welding machine 100 may be ultrasonic welding, may be thermal welding, may be laser welding, or may be any other means. For example, the welding machine 100 clamps the two end portions 2a and melts the plurality of sheet materials 10 with heat generated by ultrasonic waves or the like to form the fixing portion 3.

As illustrated in FIG. 3, a portion of the sheet material 10 is melted to form the fixing portion 3. The fixing portion 3 extends along the laminating direction Ly from one end portion 2a to the other end portion 2a. In other words, the fixing portion 3 penetrates the plurality of sheet materials 10 along the laminating direction Ly. When the fixing portion 3 is formed, the opening between the two end portions 2a is closed. As illustrated in FIG. 3, the plurality of sheet materials 10 is fixed at same locations in the opening of the protector 2.

Note that, when the protector 2 is wound around the wire harness WH, the positions of end surfaces 2c of the sheet materials 10 may be shifted. This shift occurs due to, for example, a difference between an inner circumference and an outer circumference of a portion wound around the wire harness WH. The end surface 2c of the sheet material 10 positioned at the relatively inner side protrudes with respect to the end surface 2c of the sheet material 10 positioned at the relatively outer side.

Even when such a shift occurs, one of the sheet materials 10 overlaps so as to cover the whole of another of the sheet materials 10. For example, the protector 2 in FIG. 3 has three sheet materials 10A, 10B, and 10C. The sheet material 10A is positioned on the outermost side, and the sheet material 10C is positioned on the innermost side. The sheet material 10B overlaps the sheet material 10A so as to cover the whole of sheet material 10A. The sheet material 10C overlaps the sheet material 10B so as to cover the whole of sheet material 10B.

As illustrated in FIG. 2, the wire harness protection member 1 may have a plurality of fixing portions 3. The plurality of fixing portions 3 illustrated in FIG. 2 is disposed at intervals along the axial direction X of the wire harness WH. The plurality of fixing portions 3 may be disposed at equal intervals. In a portion between the two fixing portions 3, the plurality of sheet materials 10 can slide or the plurality of sheet materials 10 can be separated. Therefore, the wire harness protection member 1 having the plurality of fixing portions 3 can be flexibly bent. In other words, the wire harness protection member 1 having the plurality of fixing portions 3 has high followability with respect to the wire harness WH routed while being bent.

Note that the sheet material 10 may have a concave portion or a convex portion. FIGS. 7 and 8 illustrate a sheet material 10 having a curved portion 13 that is curved in a spherical shape. The sheet material 10 in FIG. 7 has a plurality of curved portions 13. As illustrated in FIG. 8, the curved portion 13 is curved toward one side in the thickness direction Z of the sheet material 10. One surface of the curved portion 13 is a convex surface, and the other surface of the curved portion 13 is a concave surface.

The rigidity and bendability of the sheet material 10 can be adjusted by the arrangement of the curved portion 13. In the sheet material 10 illustrated in FIG. 9, the plurality of curved portions 13 is disposed in a grid pattern. In other words, the plurality of curved portions 13 is arranged along the first direction D1 and the second direction D2. The first direction DI is a direction along the first side 11, and the second direction D2 is a direction along the second side 12. The first direction D1 and the second direction D2 are orthogonal to each other.

In a case where the plurality of curved portions 13 is disposed in a grid pattern, a region 18 having high bendability is formed between adjacent curved portions 13. Such a sheet material 10 has high bendability in a state of being wound around the wire harness WH.

In the sheet material 10 illustrated in FIG. 10, the plurality of curved portions 13 is alternately disposed in a staggered manner. The plurality of curved portions 13 has a first row R1 and a second row R2. The first row R1 and the second row R2 have a plurality of curved portions 13 arranged in the first direction D1. The first row R1 and the second row R2 are disposed by being shifted in the first direction D1. For example, in the first direction D1, the curved portion 13 of the second row R2 is disposed between two curved portions 13 of the first row R1.

The sheet material 10 in FIG. 10 is wound around the wire harness WH with the portion along the first side 11 as the end portion 2a, for example. The sheet material 10 in which the plurality of curved portions 13 is alternately disposed has high rigidity in a state of being wound around the wire harness WH. Such a sheet material 10 can improve the rigidity of the wire harness protection member 1 against bending. Note that the sheet material 10 may have other rows in addition to the first row R1 and the second row R2. In other words, the sheet material 10 may have the curved portions 13 arranged in three or more rows.

The sheet materials 10 having the curved portions 13 may be overlapped such that the curved portions 13 are fitted to each other. In other words, a plurality of sheet materials 10 may be overlapped such that the curved portion 13 of one sheet material 10 enters the curved portion 13 of another sheet material 10. Unlike this, the plurality of sheet materials 10 may be overlapped such that the positions of the curved portions 13 are shifted. In this case, a gap is formed between the two sheet materials 10, and the rigidity and impact resistance of the wire harness protection member 1 are improved.

The protector 2 may be wound around the wire harness WH with the convex surface of the curved portion 13 facing outward. In this case, the contact between the peripheral components and the wire harness protection member 1 is a point contact, and the wear resistance of the wire harness protection member 1 is improved. In addition, since the contact area with the peripheral components is small, the occurrence of abnormal noise is suppressed.

The shape of the curved portion provided in the sheet material 10 is not limited to a spherical shape. FIG. 11 illustrates a sheet material 10 having a groove-shaped curved portion 14. The sheet material 10 has a plurality of curved portions 14. The curved portion 14 extends linearly and has an arc-shaped cross-sectional shape. The curved portion 14 in FIG. 11 extends in the second direction D2. A predetermined interval is provided between two adjacent curved portions 14. The plurality of curved portions 14 is disposed, for example, at equal intervals along the first direction D1.

The sheet material 10 is wound around the wire harness WH with a portion along the second side 12 as an end portion 2a, for example. In this case, the sheet material 10 can improve the rigidity of the wire harness protection member 1 against bending. Unlike this, the sheet material 10 may be wound around the wire harness WH with the portion along the first side 11 as the end portion 2a. In this case, the sheet material 10 can be flexibly bent by following the wire harness WH.

The sheet materials 10 having the curved portions 14 are overlapped such that the curved portions 14 are fitted to each other, for example. In other words, in the protector 2, a plurality of sheet materials 10 may be overlapped such that the curved portion 14 of one sheet material 10 enters the curved portion 14 of another sheet material 10. Unlike this, the plurality of sheet materials 10 may be overlapped such that the positions of the curved portions 14 are shifted. Note that the plurality of sheet materials 10 may be overlapped such that the curved portions 14 protrude in opposite directions. In this case, a gap is formed between the two sheet materials 10 at a portion where the convex surfaces of the curved portions 14 are in contact with each other.

The wire harness protection member 1 may have a linearly provided fixing portion 3. FIG. 12 illustrates a wire harness protection member 1 having a linear fixing portion 3. The fixing portion 3 extends linearly along the axial direction X. The fixing portion 3 is provided, for example, from one end to the other end of the end portion 2a in the axial direction X. The linear fixing portion 3 can improve the rigidity of the end portion 2a and improve the straightness of the wire harness WH.

A binding member 30 illustrated in FIG. 13 may be used as the fixing portion 3. The binding member 30 is, for example, a member called a binding band, and has a head portion 31 and a band portion 32. The band portion 32 is inserted through a through-hole 2d provided in an end portion 2a of the protector 2 and is engaged with the head portion 31. The binding member 30 fixes the plurality of sheet materials 10 to each other along the laminating direction Ly. The through-hole 2d is formed in each sheet material 10 constituting the protector 2. The plurality of sheet materials 10 is overlapped such that the through-holes 2d face each other. The exemplified protector 2 has a plurality of through-holes 2d. The plurality of through-holes 2d is disposed at intervals along the axial direction X.

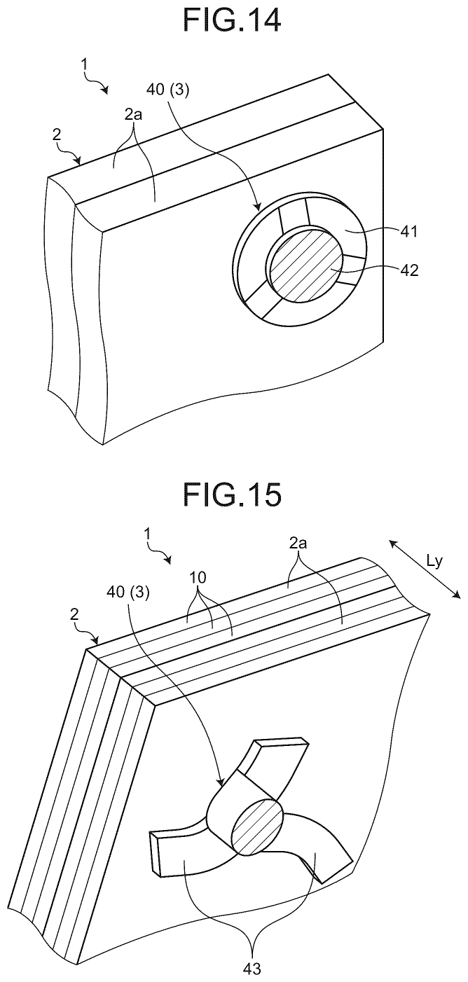

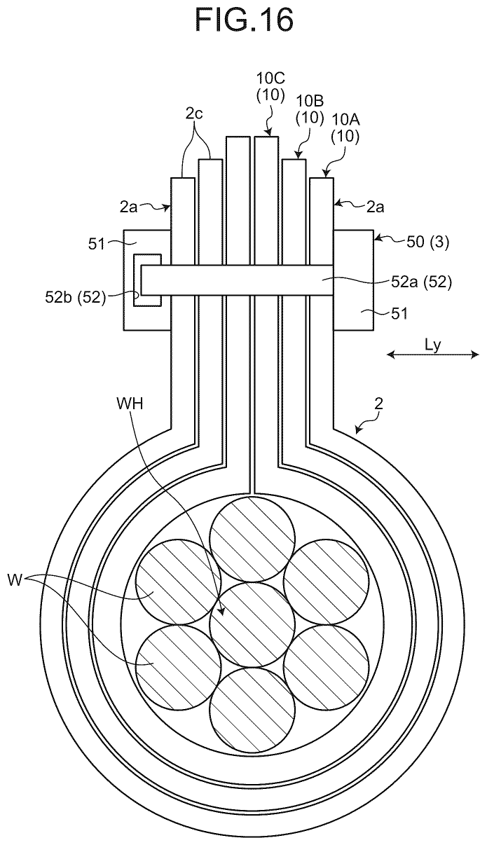

A clip 40 illustrated in FIGS. 14 and 15 may be used as the fixing portion 3. The clip 40 is a fastening member called a two-piece clip or a push rivet. The clip 40 illustrated in FIGS. 14 and 15 has a head portion 41, a pin 42, and a plurality of leg portions 43. The pin 42 penetrates through the head portion 41. The pin 42 and the leg portion 43 are inserted through the through-hole of the protector 2. The clip 40 is configured such that the leg portion 43 is expanded by pushing the pin 42. The clip 40 clamps the plurality of sheet materials 10 between the expanded leg portion 43 and the head portion 41, and fastens the two end portions 2a of the protector 2. The clip 40 fixes the plurality of sheet materials 10 to each other along the laminating direction Ly.

Note that, in the case of forming the linear fixing portion 3 as in FIG. 12, for example, a linear clip such as a clip called a food clip or a sealing clip may be used. FIG. 16 illustrates a side view of the protector 2 fastened by a linear clip 50. The clip 50 has two holders 51 and an engaging structure 52. The clip 50 is molded of, for example, an insulating synthetic resin.

The holder 51 clamps and holds the two end portions 2a of the protector 2. The two holders 51 are formed in a plate shape or a rod shape, and face each other in the laminating direction Ly with the two end portions 2a interposed therebetween. The engaging structure 52 engages the two holders 51. The engaging structure 52 is constituted by, for example, an engaging arm 52a included in one of the holders 51 and a locking portion 52b included in another of the holders 51. In this case, the locking portion 52b locks the engaging arm 52a in the laminating direction Ly. The engaging structures 52 are disposed at both ends in the axial direction X with respect to the holder 51. The clip 50 can fix the plurality of sheet materials 10 to each other along the laminating direction Ly. Note that, in addition to both ends of the holder 51, a further engaging structure may be provided at the intermediate portion of the holder 51.

Another configuration example of the sheet material 10 will now be described. The sheet material 10 illustrated in FIG. 17 has a base material layer 15 and an adhesive layer 16. The base material layer 15 is a main body of the sheet material 10 and is molded of, for example, soft polyvinyl chloride (PVC). The adhesive layer 16 is formed by, for example, applying an adhesive to the base material layer 15. The adhesive layer 16 may be an adhesive sheet or an adhesive tape attached to the base material layer 15.

The sheet material 10 is bonded to another sheet material 10 by the adhesive layer 16. The plurality of sheet materials 10 is overlapped as illustrated in FIG. 18, for example. In the protector 2 in FIG. 18, the adhesive layer 16 is positioned on the same side with respect to the base material layer 15 in all the sheet materials 10. The protector 2 illustrated in FIG. 18 is wound around the wire harness WH such that, for example, the adhesive layer 16 exposed on the surface layer faces the wire harness WH.

In this case, as illustrated in FIG. 19, the adhesive layer 16 can be bonded to the wire harness WH to restrain the wire harness WH. As a result, the wire harness protection member 1 can improve the straightness of the wire harness WH. In addition, since the plurality of sheet materials 10 is bonded to each other, the wire harness protection member 1 can improve the straightness of the wire harness WH.

The end portions 2a of the protector 2 wound around the wire harness WH are fixed to each other by the fixing portion 3. The fixing portion 3 may be formed by welding, or may be a member such as a binding member or a clip. When the fixing portion 3 is a binding member or a clip, the through-hole 2d is provided in the base material layer 15 and the adhesive layer 16.

The plurality of fixing portions 3 may be disposed along the axial direction X with respect to the protector 2 having the adhesive layer 16, or the linear fixing portion 3 may be disposed along the axial direction X with respect to the protector 2. The two end portions 2a are fixed to each other by the adhesive layer 16 in addition to the fixing portion 3. Therefore, the fixing strength at the opening is improved.

Note that the plurality of sheet materials 10 may be overlapped such that the base material layer 15 faces the wire harness WH. In this case, as illustrated in FIG. 20, the adhesive layer 16 of the sheet material 10 disposed at the end portion in the laminating direction Ly faces the adhesive layer 16 of another sheet material 10. In other words, the adhesive layers 16 of the two sheet materials 10 are bonded to each other. Such a protector 2 is wound around the wire harness WH by facing the base material layer 15 to the wire harness WH. In this case, since the wire harness protection member 1 is less likely to restrain the movement of the wire harness WH, the bendability of the wire harness WH can be improved. Note that, as the sheet material 10 disposed at the end portion in the laminating direction Ly, a sheet material 10 not having the adhesive layer 16 may be used.

The sheet material 10 having the adhesive layer 16 may have a curved portion 13 having a spherical shape, may have a curved portion 14 having a groove shape, or may have a curved portion having any other shape. The plurality of sheet materials 10 having the curved portions 13 may be overlapped such that the curved portions 13 are fitted to each other, or may be overlapped such that the positions of the curved portions 13 are shifted. The plurality of sheet materials 10 having the curved portions 14 may be overlapped such that the curved portions 14 are fitted to each other, or may be overlapped such that the positions of the curved portions 14 are shifted.

As described above, the wire harness protection member 1 of the present embodiment has the protector 2 and the fixing portion 3. The protector 2 is constituted of the plurality of sheet materials 10 overlapping each other. The fixing portion 3 fixes both end portions 2a of the protector 2 to each other. The plurality of sheet materials 10 has same materials and same shapes.

In the protector 2, the plurality of sheet materials 10 overlaps each other such that one of the sheet materials 10 covers the whole of another of the sheet materials 10. The protector 2 has an inner side surface 2b facing the wire harness WH in a state of being wound around the wire harness WH. The protector 2 is wound around the wire harness WH by facing the inner side surfaces 2b of both end portions 2a of the protector 2 to each other. The fixing portion 3 fixes the plurality of sheet materials 10 to each other along the laminating direction Ly in which the plurality of sheet materials 10 is laminated. In the wire harness protection member 1 according to the present embodiment, protection members having different required protection performances can be manufactured from the same sheet material 10. Therefore, according to the wire harness protection member 1 of the present embodiment, it is possible to reduce the number of types of components required for protection members having different protection performances.

The sheet material 10 may have the base material layer 15 and the adhesive layer 16, and be bonded to another sheet material 10 by the adhesive layer 16. Such a sheet material 10 can improve the rigidity of the wire harness protection member 1.

The fixing portion 3 may be formed by welding the plurality of sheet materials 10. In this case, it is possible to automate the process of forming the fixing portion 3 and improve the efficiency.

In the wire harness protection member 1, the plurality of fixing portions 3 may be disposed at intervals along the axial direction X of the wire harness WH. In this case, the wire harness protection member 1 can be flexibly bent.

Note that, in a case where the protector 2 is constituted by the sheet material 10 not having the adhesive layer 16, a configuration for suppressing the positional shift of the sheet material 10 may be provided. For example, as illustrated in FIG. 21, a welding portion 17 which welds the plurality of sheet materials 10 may be formed. The protector 2 in FIG. 21 has a plurality of welding portions 17. The welding portion 17 is formed so as to penetrate the protector 2 along the laminating direction Ly.

The plurality of welding portions 17 is disposed along the axial direction X of the wire harness WH when wound around the wire harness WH. In the protector 2 in FIG. 21, the plurality of welding portions 17 is arranged in the second direction D2. In this case, the protector 2 is wound around the wire harness WH such that the wire harness WH extends in the second direction D2. The plurality of welding portions 17 are disposed at intervals, so that the bendability of the wire harness protection member 1 is improved. The welding portion 17 is disposed, for example, at a central portion of the protector 2 in the first direction D1.

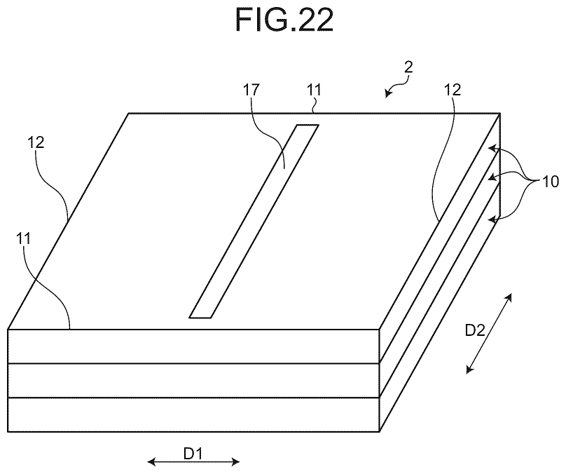

As illustrated in FIG. 22, the welding portion 17 may be formed linearly. The welding portion 17 in FIG. 22 extends along the axial direction X of the wire harness WH when wound around the wire harness WH. The linear welding portion 17 can improve the straightness of the wire harness protection member 1.

In a case where the protector 2 is constituted by the sheet material 10 not having the adhesive layer 16, a jig for suppressing the positional shift of the sheet material 10 may be used. For example, a jig having a positioning pin penetrating the protector 2 is used. In this case, for example, each sheet material 10 is provided with a through- hole corresponding to the positioning pin. The jig supports the protector 2 and positions the plurality of sheet materials 10 by the positioning pins. The wire harness WH is placed in the protector 2, for example, supported by a jig.

Note that the shape of the sheet material 10 is not limited to the shape exemplified in the embodiment. The shape of the sheet material 10 in plan view may be a polygonal shape such as a hexagonal shape, may be an oblong shape, or may be any other shape.

The contents disclosed in the above embodiments can be performed in combination as appropriate.

A wire harness protection member according to the present embodiment has: a protector constituted by a plurality of sheet materials overlapping each other; and a fixing portion which fixes both end portions of the protector to each other, in which the fixing portion fixes the plurality of sheet materials to each other along a laminating direction in which the plurality of sheet materials is laminated. In the wire harness protection member according to the present embodiment, the protection performance can be adjusted by the number of the sheet materials constituting the protector, or the like. Therefore, the wire harness protection member according to the present embodiment has an effect of capable of realizing the required protection performance.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness protection member comprising:
a protector constituted of a plurality of sheet materials overlapping each other; and
a fixing portion which fixes both end portions of the protector to each other, wherein
the plurality of sheet materials has same materials and same shapes,
in the protector, the plurality of sheet materials overlaps each other such that one of the sheet materials covers a whole of another of the sheet materials,
the protector has an inner side surface facing a wire harness in a state of being wound around the wire harness, and is wound around the wire harness by facing the inner side surfaces of both end portions of the protector to each other, and
the fixing portion fixes the plurality of sheet materials to each other along a laminating direction in which the plurality of sheet materials is laminated.

2. The wire harness protection member according to claim 1, wherein
each of the sheet materials has a base material layer and an adhesive layer, and is bonded to another of the sheet materials by the adhesive layer.

3. The wire harness protection member according to claim 1, wherein
the fixing portion is formed by welding the plurality of sheet materials.

4. The wire harness protection member according to claim 1, wherein
a plurality of the fixing portions is disposed at intervals along an axial direction of the wire harness.

5. The wire harness protection member according to claim 2, wherein
a plurality of the fixing portions is disposed at intervals along an axial direction of the wire harness.

6. The wire harness protection member according to claim 3, wherein
a plurality of the fixing portions is disposed at intervals along an axial direction of the wire harness.
